(19) United States
(12) Patent Application Publication
(10) Pub. No.: US 2022/0379772 A1
(43) Pub. Date: Dec. 1, 2022

(54) CONTROL DEVICE, DISASTER SUPPORT SYSTEM, AND STORAGE MEDIUM

(71) Applicant: TOYOTA JIDOSHA KABUSHIKI KAISHA, Toyota-shi (JP)

(72) Inventors: Yusuke HOKI, Mishima-shi (JP); Koseki SUGIYAMA, Sunto-gun (JP); Kumiko KATSUMATA, Susono-shi (JP); Rie YAYABE, Sunto-gun (JP); Shin SAKURADA, Toyota-shi (JP); Tomio YAMANAKA, Nagoya-shi (JP)

(73) Assignee: TOYOTA JIDOSHA KABUSHIKI KAISHA, Toyota-shi (JP)

(21) Appl. No.: 17/704,921

(22) Filed: Mar. 25, 2022

(30) Foreign Application Priority Data
Jun. 1, 2021 (JP) 2021-092534

(51) Int. Cl. B60L 58/13; B60L 58/18; B60L 53/53

(52) U.S. Cl. CPC B60L 58/13; B60L 58/18; B60L 53/53

(57) ABSTRACT

A control device is provided with an ECU configured to acquire a charging rate of a secondary battery, generate power supply information related to power supply using an in-vehicle outlet based on the charging rate, and output the power supply information.

### CROSS-REFERENCE TO RELATED APPLICATION

This application claims priority to Japanese Patent Application No. 2021-092534 filed on Jun. 1, 2021, incorporated herein by reference in its entirety.

### BACKGROUND

### 1. Technical Field

The present disclosure relates to a control device, a disaster support system, and a storage medium.

### 2. Description of Related Art

Japanese Unexamined Patent Application Publication No. 2018-45304 (JP 2018-45304 A) discloses a technique for transmitting at least one of a power consumption amount supplied to a power supply target device and a billing amount calculated from the power consumption amount to a user terminal.

### SUMMARY

In recent years, a vehicle equipped with a storage battery such as a secondary battery is provided with an in-vehicle outlet, and electric power is supplied from the storage battery to an electric appliance connected to the in-vehicle outlet.

However, in JP 2018-45304 A, at least one of the power consumption amount and the billing amount is transmitted. Therefore, the user cannot understand power supply information related to power supply, such as the specific usable number of times or the usable time of the electric appliance based on the current state of charge (SOC) of the storage battery.

The present disclosure has been made in view of the above, and an object of the present disclosure is to provide a control device, a disaster support system, and a storage medium allowing the user to understand power supply information related to power supply by a storage battery mounted on a vehicle.

An control device according to the present disclosure includes a processor configured to: acquire a charging rate of a secondary battery from a vehicle provided with the secondary battery that is able to supply power to an outside and an outlet that is electrically connected to the secondary battery and with which the power is able to be supplied to an electric appliance; generate power supply information related to the power supply by the inlet based on the charging rate; and output the power supply information.

According to the present disclosure, an effect that the user can understand the power supply information by the storage battery mounted on the vehicle can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a disaster support system according to a first embodiment;

FIG. 2 is a block diagram showing a functional configuration of a vehicle according to the first embodiment;

FIG. 3 is a flowchart showing an outline of a process executed by the vehicle according to the first embodiment;

FIG. 4 is a diagram showing an example of power supply information;

FIG. 5 is a diagram showing an example of usable time information related to usable time output by an output control unit of the vehicle according to the first embodiment;

FIG. 6 is a block diagram showing a functional configuration of communication equipment according to a second embodiment;

FIG. 7 is a flowchart showing an outline of a process executed by the communication equipment according to the second embodiment;

FIG. 8 is a diagram schematically illustrating an example of the detection process executed by a detection unit of the communication equipment according to the second embodiment;

FIG. 9 is a diagram showing an example of at least one of the usable number of times and the usable time output by the output control unit of the communication equipment according to the second embodiment;

FIG. 10 is a diagram showing a schematic configuration of a disaster support system according to the third embodiment;

FIG. 11 is a block diagram showing a functional configuration of a support server according to the third embodiment; and

FIG. 12 is a flowchart showing an outline of a process executed by the support server according to the third embodiment.

### DETAILED DESCRIPTION OF EMBODIMENTS

Hereinafter, a control device, a disaster support system, and a storage medium according to an embodiment of the present disclosure will be described with reference to the drawings. Note that, the present embodiment does not limit the present disclosure. Further, in the following, the same portions will be described with the same reference numerals.

### First Embodiment

### Outline Configuration of Disaster Support System

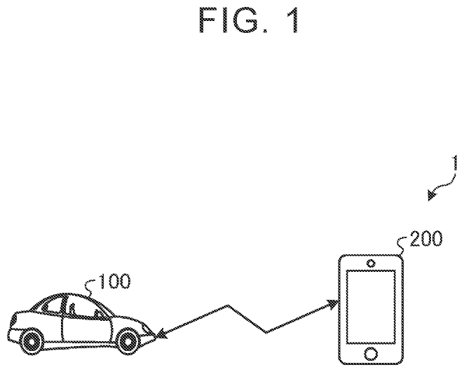

FIG. 1 is a diagram showing a schematic configuration of a disaster support system according to a first embodiment. A disaster support system 1 shown in FIG. 1 includes a vehicle 100 and communication equipment 200 that is communicable with the vehicle 100 in accordance with a predetermined communication standard. Here, the predetermined communication standard is at least one of Bluetooth (registered trademark) and Wi-Fi (registered trademark). The vehicle 100 is any one of a battery electric vehicle (BEV), a hybrid electric vehicle (HEV), a hybrid vehicle (HV), a plug-in hybrid vehicle (PHV), a plug-in hybrid electric vehicle (PHEV), or a fuel cell electric vehicle (FCEV). Further, the communication equipment 200 is, for example, a mobile phone, a tablet-type communication terminal, or the like. Note that, in the following, the vehicle 100 will be described as a PHV.

### Functional Configuration of Vehicle

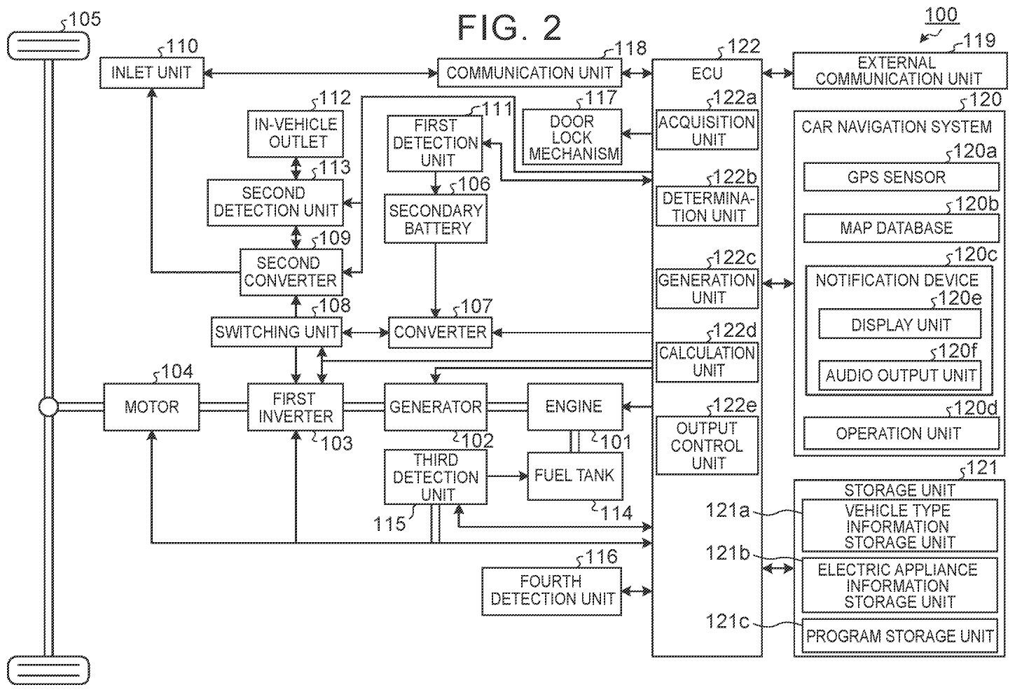

First, the detailed functional configuration of the vehicle 100 will be described. FIG. 2 is a block diagram showing the functional configuration of the vehicle 100. As shown in FIG. 2, the vehicle 100 includes an engine 101, a generator 102, a first inverter 103, a motor 104, drive wheels 105, a secondary battery 106, a converter 107, a switching unit 108, a second inverter 109, an inlet unit 110, a first detection unit 111, an in-vehicle outlet 112, a second detection unit 113, a fuel tank 114, a third detection unit 115, a fourth detection unit 116, a door lock mechanism 117, a communication unit 118, an external communication unit 119, a car navigation system 120, a storage unit 121, and an electric control unit (ECU) 122.

The engine 101 is composed of a known internal combustion engine, and outputs power using fuel stored in the fuel tank 114. The engine 101 is driven under the control of the ECU 122. The power output from the engine 101 drives the generator 102.

The generator 102 is electrically connected to the motor 104 via the first inverter 103. Under the control of the ECU 122, the generator 102 supplies the generated alternate current (AC) power to the secondary battery 106 via the switching unit 108 and the converter 107. The generator 102 is configured using a power generation motor generator provided with a motor function in addition to a power generation function.

Under the control of the ECU 122, the first inverter 103 converts the discharge power (direct current (DC) power) from the secondary battery 106 supplied via the switching unit 108 and the converter 107 into the AC power, and supplies the converted AC power to the motor 104. Further, under the control of the ECU 122, the first inverter 103 converts the AC power generated by the motor 104 into the DC power at the time of regenerative braking of the vehicle 100, and supplies the converted DC power to the secondary battery 106 via the switching unit 108 and the converter 107. The first inverter 103 is configured using, for example, a three-phase inverter circuit including a bridge circuit including switching elements for three phases.

The motor 104 is driven by the AC power supplied from the first inverter 103 when the vehicle 100 is accelerated under the control of the ECU 122. The power output from the motor 104 drives the drive wheels 105. Further, under the control of the ECU 122, the motor 104 functions as a generator that generates power by an external force transmitted from the drive wheels 105 when the vehicle 100 is braked, and the generated power is supplied from the first inverter 103 to the secondary battery 106 via the switching unit 108 and the converter 107. The motor 104 is configured using a driving motor generator provided with the motor function in addition to the power generation function.

The secondary battery 106 is configured using, for example, a chargeable and dischargable storage battery such as a nickel hydrogen battery or a lithium ion battery, or a power storage element such as an electric double layer capacitor. The secondary battery 106 can be charged and discharged by the converter 107, and stores high-voltage DC power.

One end of the converter 107 is electrically connected to the secondary battery 106, and the other end is electrically connected to one of the first inverter 103 and the second inverter 109 via the switching unit 108. The converter 107 charges and discharges the secondary battery 106 under the control of the ECU 122. Specifically, when the secondary battery 106 is charged, the converter 107 steps down the DC power that is supplied from the outside via the second inverter 109, the inlet unit 110, and the switching unit 108 to a predetermined voltage, and the stepped-down charging current is supplied to the secondary battery 106. On the other hand, when the secondary battery 106 is discharged, the converter 107 boosts the voltage of the DC power from the secondary battery 106, and the boosted discharge current is supplied to the first inverter 103 via the switching unit 108.

One end of the switching unit 108 is electrically connected to the converter 107, and the other end is electrically connected to one of the first inverter 103 and the second inverter 109. The switching unit 108 electrically connects the converter 107 and one of the first inverter 103 and the second inverter 109 under the control of the ECU 122. The switching unit 108 is configured using a mechanical relay, a semiconductor switch, or the like.

One end of the second inverter 109 is electrically connected to the switching unit 108, and the other end is electrically connected to the inlet unit 110 or the in-vehicle outlet 112. Under the control of the ECU 122, the second inverter 109 converts the discharge power (DC power) supplied from the secondary battery 106 via the switching unit 108 and the converter 107 into the AC power, and supplies the converted AC power to the inlet unit 110. Specifically, the second inverter 109 supplies the AC power to the outside via the inlet unit 110 and a charge-discharge cable (not shown) under the control of the ECU 122. The second inverter 109 is configured using a single-phase inverter circuit or the like so as to correspond to the form of electric power used externally.

One end of the inlet unit 110 is electrically connected to the second inverter 109. A charge-discharge cable (not shown) is detachably connected to the inlet unit 110. The inlet unit 110 supplies the AC power that is supplied from the outside to the second inverter 109 via the charge-discharge cable, and outputs various types of information including control signals and the like that are input from the outside to the communication unit 118. Further, the inlet unit 110 externally supplies the AC power supplied from the second inverter 109 via the charge-discharge cable, and externally outputs various control signals from that are input the ECU 122 via the communication unit 118.

The first detection unit 111 detects each of the SOC (charging rate), a temperature, a state of health (SOH), a voltage value, and a current value of the secondary battery 106, and outputs the detection results to the ECU 122. The first detection unit 111 is configured using an ammeter, a voltmeter, a temperature sensor, and the like.

The in-vehicle outlet 112 is electrically connected to the second inverter 109. A power plug of a general electric appliance can be connected to the in-vehicle outlet 112. The AC power supplied from the second inverter 109 is supplied to the electric appliance of which power plug is connected.

The second detection unit 113 is provided between the in-vehicle outlet 112 and the second inverter 109, detects at least one of power consumption and a current value of the electric appliance connected to the in-vehicle outlet 112, and outputs the detection result to the ECU 122. The second detection unit 113 is configured using a wattmeter, an ammeter, a voltmeter, and the like.

The fuel tank 114 stores fuel supplied to the engine 101. Here, the fuel is a fossil fuel such as gasoline. Note that, when the vehicle 100 is an FCEV, hydrogen fuel is stored.

The third detection unit 115 detects the remaining amount of fuel stored in the fuel tank 114, and outputs the detection result to the ECU 122. The third detection unit 115 is configured using a fuel gauge or the like.

The fourth detection unit 116 detects the environmental information around the vehicle 100 and outputs the detection result to the ECU 122. Here, the environmental information is temperature, humidity, time, date and time, and the like. The fourth detection unit 116 is configured using a thermometer, a hygrometer, a clock, or the like.

The door lock mechanism 117 operates to open and close the doors provided in the vehicle 100 under the control of the ECU 122.

The communication unit 118 receives a control signal including various types of information input from the outside via the inlet unit 110, and outputs the received control signal to the ECU 122. Further, the communication unit 118 outputs a control signal including control area network (CAN) data and the like input from the ECU 122 to the inlet unit 110. The communication unit 118 is configured using a communication module or the like.

Under the control of the ECU 122, the external communication unit 119 transmits various types of information input from the ECU 122 to the communication equipment 200 in accordance with a predetermined communication standard. Further, the external communication unit 119 outputs various types of information received from the communication equipment 200 to the ECU 122. Here, the predetermined communication standard is at least one of Bluetooth (registered trademark) and Wi-Fi (registered trademark). The external communication unit 119 is configured using a communication module or the like.

The car navigation system 120 includes a global positioning system (GPS) sensor 120a, a map database 120b, a notification device 120c, and an operation unit 120d.

The GPS sensor 120a receives signals from a plurality of GPS satellites or transmission antennas, and calculates position information related to the position (longitude and latitude) of the vehicle 100 based on the received signals. The GPS sensor 120a is configured using a GPS receiving sensor or the like. In the first embodiment, the orientation accuracy of the vehicle 100 may be improved by mounting a plurality of the GPS sensors 120a.

The map database 120b stores various types of map data. The map database 120b is configured using a storage medium such as a hard disk drive (HDD) or a solid state drive (SSD).

The notification device 120c includes a display unit 120e that displays images, maps, videos, and character information, and an audio output unit 120f that generates sounds such as voices and alarm sounds. The display unit 120e is configured using a display such as a liquid crystal display or an organic electroluminescence (EL). The audio output unit 120f is configured using a speaker or the like.

The operation unit 120d receives an input of the operation by the user and outputs signals corresponding to the various received operation contents to the ECU 122. The operation unit 120d is realized using a touch panel, buttons, switches, a jog dial, and the like.

The car navigation system 120 configured as described above superimposes the position information related to the current position of the vehicle 100 acquired by the GPS sensor 120a on the map corresponding to the map data stored in the map database 120b, whereby the user is notified of information including the road on which the vehicle 100 is currently traveling and a traveling route to the destination using the display unit 120e and the audio output unit 120f.

The storage unit 121 stores various types of information related to the vehicle 100. The storage unit 121 stores CAN data of the vehicle 100 input from the ECU 122, data during various processes executed by the ECU 122, and the like. The storage unit 121 includes a vehicle type information storage unit 121a related to the vehicle 100, an electric appliance information storage unit 121b in which a plurality of pre-registered electric appliances and power consumption are associated with each other, and a program storage unit 121c that stores various programs executed by the vehicle 100. Here, the vehicle type information includes a vehicle type of the vehicle 100, identification information for identifying the vehicle 100, a model year of the vehicle 100, presence or absence of power generation, information indicating any one of BEV, HV, HEV, PHV, PHEV, and FCEV. The storage unit 121 is configured using a DRAM, a ROM, a flash memory, an SSD, or the like.

The ECU 122 is configured using a memory and a processor provided with hardware such as a central processing unit (CPU). The ECU 122 controls the operation of each unit constituting the vehicle 100. The ECU 122 includes an acquisition unit 122a, a determination unit 122b, a generation unit 122c, a calculation unit 122d, and an output control unit 122e. Note that, in the first embodiment, the ECU 122 functions as a control device.

The acquisition unit 122a acquires the SOC (charging rate) of the secondary battery 106 from the first detection unit 111. Further, the acquisition unit 122a acquires the vehicle type information of the vehicle 100 from the vehicle type information storage unit 121a of the storage unit 121. Further, the acquisition unit 122a acquires the SOC of the secondary battery 106 from the first detection unit 111, acquires the remaining amount of fuel in the fuel tank 114 from the third detection unit 115, and acquires the environmental information detected by the fourth detection unit 116.

The determination unit 122b determines whether predetermined information has been input via the external communication unit 119 or the operation unit 120d. Here, the predetermined information is any one of disaster information for notifying a disaster, disaster prevention information for suppressing the spread of damage in the event of a disaster, and operation procedure information. Further, examples of the disaster include a storm, heavy rain, heavy snowfall, flood, storm surge, tsunami and eruption. Further, the operation procedure information is operation information input from the operation unit 120d by the user as the user operates the operation unit 120d when the user calls the operation procedure for confirming how to use the in-vehicle outlet 112. Further, the determination unit 122b determines whether the vehicle 100 is provided with the power generation function capable of supplying power to the secondary battery 106 using a predetermined fuel based on the vehicle type information acquired by the acquisition unit 122a.

The generation unit 122c generates power supply information related to power supply from the in-vehicle outlet 112 based on the SOC of the secondary battery 106 acquired by the acquisition unit 122a. Here, specifically, the power supply information includes at least the rated output power, the charging rate, and the power supply available time. The generation unit 122c generates the power supply information based on a power supply electric energy calculated by the calculation unit 122d that will be described later, the SOC of the secondary battery 106, the remaining amount of fuel in the fuel tank 114, and the environmental information detected by the fourth detection unit 116.

The calculation unit 122d calculates the power supply electric energy that the secondary battery 106 of the vehicle 100 can supply to the outside based on the SOC of the secondary battery 106 acquired by the acquisition unit 122a. Specifically, when the vehicle 100 is provided with the power generation function, the calculation unit 122d calculates the power supply electric energy that can be supplied to the outside based on the SOC of the secondary battery 106, the amount of power generated by power generation using the remaining amount of fuel in the fuel tank 114, and the temperature included in the environmental information.

The output control unit 122e outputs the power supply information generated by the generation unit 122c. Specifically, when the communication equipment 200 is communicably connected to the vehicle 100, the output control unit 122e outputs the power supply information generated by the generation unit 122c to the communication equipment 200 via the external communication unit 119. Further, when the communication equipment 200 is not communicably connected to the vehicle 100, the output control unit 122e outputs the power supply information generated by the generation unit 122c to the display unit 120e.

### Process Executed by Vehicle

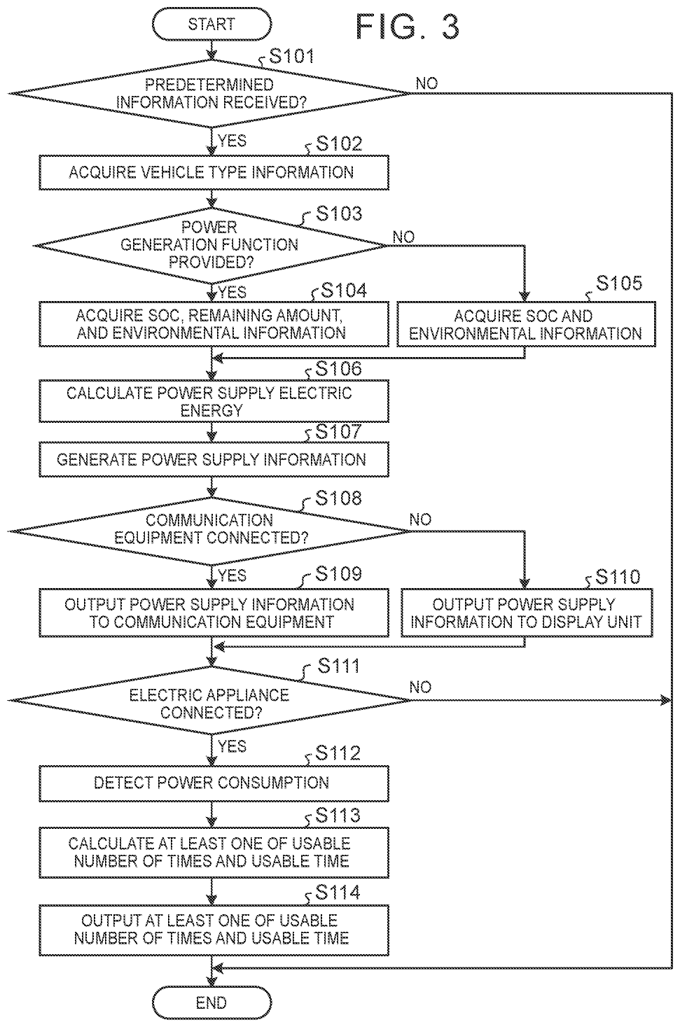

Next, a process executed by the vehicle 100 will be described. FIG. 3 is a flowchart showing an outline of the process executed by the vehicle 100.

As shown in FIG. 3, first, the determination unit 122b determines whether the predetermined information has been input via the external communication unit 119 or the operation unit 120d (step S101). Here, the predetermined information is any one of disaster information for notifying a disaster, disaster prevention information for preventing the spread of damage in the event of a disaster, and operation procedure information. When the determination unit 122b determines that the predetermined information has been input via the external communication unit 119 or the operation unit 120d (step S101: Yes), the vehicle 100 proceeds to step S102 that will be described later. On the other hand, when the determination unit 122b determines that the predetermined information has not been input via the external communication unit 119 or the operation unit 120d (step S101: No), the vehicle 100 ends this process.

In step S102, the acquisition unit 122a acquires the vehicle type information of the vehicle 100 from the vehicle type information storage unit 121a of the storage unit 121.

Subsequently, the determination unit 122b determines whether the vehicle 100 is provided with the power generation function based on the vehicle type information of the vehicle 100 (step S103). When the determination unit 122b determines that the vehicle 100 is provided with the power generation function (step S103: Yes), the vehicle 100 proceeds to step S104 that will be described later. On the other hand, when the determination unit 122b determines that the vehicle 100 is not provided with the power generation function (step S103: No), the vehicle 100 proceeds to step S105 that will be described later.

In step S104, the acquisition unit 122a acquires the SOC of the secondary battery 106 from the first detection unit 111, acquires the remaining amount of fuel in the fuel tank 114 from the third detection unit 115, and acquires the environmental information detected by the fourth detection unit 116. After step S104, the vehicle 100 proceeds to step S106 that will be described later.

In step S105, the acquisition unit 122a acquires the SOC of the secondary battery 106 from the first detection unit 111, and acquires the environmental information detected by the fourth detection unit 116. After step S104, the vehicle 100 proceeds to step S106 that will be described later.

In step S106, the calculation unit 122d calculates the power supply electric energy that the vehicle 100 can supply to the outside based on the acquisition result acquired by the acquisition unit 122a in step S104 or step S105. Specifically, when the vehicle 100 is provided with the power generation function, the calculation unit 122d calculates the power supply electric energy that can be supplied to the outside based on the SOC of the secondary battery 106, the amount of power generated by power generation using the remaining amount of fuel in the fuel tank 114, and the temperature included in the environmental information.

Subsequently, the generation unit 122c generates the power supply information related to power supply from the in-vehicle outlet 112 of the vehicle 100 based on the power supply electric energy calculated by the calculation unit 122d (step S107).

Subsequently, the determination unit 122b determines whether the vehicle 100 is communicably connected to the communication equipment 200 via the external communication unit 119 (step S108). For example, the determination unit 122b determines whether pairing between the vehicle 100 and the communication equipment 200 is completed via the external communication unit 119. When the pairing is completed, the determination unit 122b determines that the vehicle 100 is communicably connected to the communication equipment 200. When the determination unit 122b determines that the vehicle 100 is communicably connected to the communication equipment 200 via the external communication unit 119 (step S108: Yes), the vehicle 100 proceeds to step S109 that will be described later. On the other hand, when the determination unit 122b determines that the vehicle 100 is not communicably connected to the communication equipment 200 via the external communication unit 119 (step S108: No), the vehicle 100 proceeds to step S110 that will be described later.

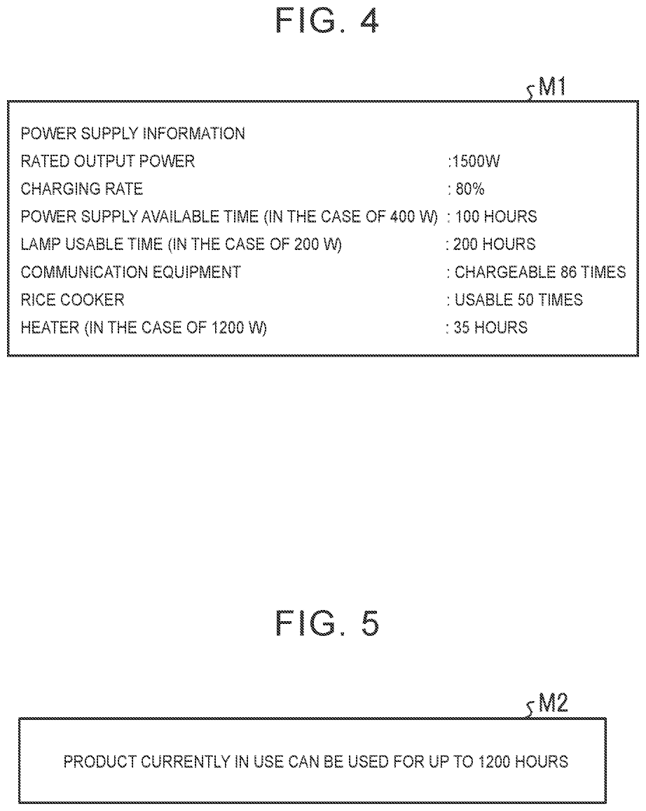

In step S109, the output control unit 122e outputs the power supply information generated by the generation unit 122c to the communication equipment 200 via the external communication unit 119. In this case, the communication equipment 200 displays the power supply information output from the vehicle 100. FIG. 4 is a diagram showing an example of the power supply information. As shown in FIG. 4, the output control unit 122e outputs power supply information M1 generated by the generation unit 122c to the communication equipment 200 via the external communication unit 119. As shown in FIG. 4, the power supply information M1 at least indicates that the rated output power is “1500 W”, the SOC (charging rate) is “80% ”, and the power supply available time is “100 hours”. Further, as shown in FIG. 4, the power supply information M1 indicates an example in the case of using each electric appliance. For example, as shown in FIG. 4, the power supply information M1 indicates that a lamp usable time (in the case of 200 W) is “200 hours”, the number of chargeable times of the communication equipment 200 is “86 times”, a rice cooker is “usable 50 times”, and the usable time of a heater (in the case of 1200 W) is “35 hours”. Although the power supply information M1 indicates the power supply available time depending on time, the power supply information M1 may indicate an electric energy, for example, 1200 Wh. With this configuration, the user of the vehicle 100 can understand that the power can be supplied to the vehicle 100 via the communication equipment 200. After step S109, the vehicle 100 proceeds to step S111 that will be described later.

In step S110, the output control unit 122e outputs the power supply information (for example, see FIG. 4) generated by the generation unit 122c to the display unit 120e. With this configuration, the user of the vehicle 100 can understand that the power can be supplied to the vehicle 100 via the communication equipment 200. After step S110, the vehicle 100 proceeds to step S111 that will be described later.

In step S111, the determination unit 122b determines whether the electric appliance is connected to the in-vehicle outlet 112 based on the detection result of the second detection unit 113. Specifically, when the second detection unit 113 detects power consumption, the determination unit 122b determines that the electric appliance is connected to the in-vehicle outlet 112. On the other hand, the second detection unit 113 determines that the electric appliance is not connected to the in-vehicle outlet 112 when the second detection unit 113 does not detect power consumption. When the determination unit 122b determines that the electric appliance is connected to the in-vehicle outlet 112 (step S111: Yes), the vehicle 100 proceeds to step S112 that will be described later. On the other hand, when the determination unit 122b determines that the electric appliance is not connected to the in-vehicle outlet 112 (step S111: No), the vehicle 100 ends this process.

In step S112, the acquisition unit 122a acquires the power consumption of the electric appliance (hereinafter simply referred to as “used electric appliance”) connected to the in-vehicle outlet 112 from the second detection unit 113. Also in this case, the acquisition unit 122a may acquire the current value detected by the second detection unit 113 in addition to the power consumption detected by the second detection unit 113.

Subsequently, the calculation unit 122d calculates at least one of the usable number of times and the usable time of the used electric appliance based on the power consumption of the used electric appliance acquired by the acquisition unit 122a and the power supply electric energy calculated in step S106 (step S113).

After that, the output control unit 122e outputs at least one of the usable number of times and the usable time of the used electric appliance calculated by the calculation unit 122d to at least one of the communication equipment 200 and the display unit 120e (step S114). FIG. 5 is a diagram showing an example of usable time information related to the usable time output by the output control unit 122e. As shown in FIG. 5, the output control unit 122e outputs usable time information M2 related to the usable time of the used electric appliance calculated by the calculation unit 122d. With this configuration, the user can intuitively understand at least one of the usable number of times and the usable time of the used electric appliance that is currently used even when the user cannot know the power consumption of the used electric appliance. After step S114, the vehicle 100 ends this process.

According to the first embodiment described above, the output control unit 122e outputs the power supply information generated by the generation unit 122c to the communication equipment 200 or the display unit 120e, whereby the user can understand the power supply information related to the power supply by the secondary battery 106 mounted on the vehicle 100.

Further, according to the first embodiment, the power supply information includes at least the rated output power, the SOC, and the power supply available time. Therefore, the user can understand the electric appliance that can be used and the power supply time with the power supply using the in-vehicle outlet 112.

Further, according to the first embodiment, the determination unit 122b determines whether the vehicle 100 is provided with the power generation function capable of supplying power to the secondary battery 106 using the predetermined fuel based on the vehicle type information acquired by the acquisition unit 122a. When the vehicle 100 is provided with the power generation function, the remaining amount of fuel is acquired from the third detection unit 115. Then, the generation unit 122c generates the power supply information based on the remaining amount of fuel and the SOC of the secondary battery 106. With this configuration, the user can understand the power supply information to which the power generation by the vehicle 100 is added.

Further, according to the first embodiment, the calculation unit 122d calculates the power supply electric energy that the secondary battery 106 can supply based on the environmental information acquired by the acquisition unit 122a from the fourth detection unit 116, the remaining amount of fuel acquired from the third detection unit 115, and the SOC of the secondary battery 106 acquired from the first detection unit 111. After that, the generation unit 122c generates the power supply information based on the power supply electric energy calculated by the calculation unit 122d. As a result, the user can understand accurate power supply information in consideration of conditions such as the temperature.

Further, according to the first embodiment, the generation unit 122c calculates at least one of the usable number of times and the usable time of each of the preset electric appliances based on the power supply electric energy calculated by the calculation unit 122d, and the output control unit 122e outputs at least one of the usable number of times and the usable time of each of the electric appliances. With this configuration, the user can understand the specific usable number of times or the usable time of the electric appliance.

Further, according to the first embodiment, the calculation unit 122d calculates at least one of the usable number of times and the usable time of the used electric appliance based on the power consumption of the electric appliance acquired by the acquisition unit 122a from the second detection unit 113 and the power supply information, and the output control unit 122e outputs at least one of the usable number of times and the usable time of the used electric appliance. With this configuration, the user can understand the specific usable number of times and usable time of the used electric appliance that is used via the in-vehicle outlet 112.

Further, according to the first embodiment, the output control unit 122e outputs the power supply information generated by the generation unit 122c to the communication equipment 200 associated with the vehicle 100. With this configuration, the user of the vehicle 100 can know the power supply function provided in the vehicle 100 via the communication equipment 200.

Further, according to the first embodiment, when the vehicle 100 receives at least one of the disaster information and the disaster prevention information from the outside, the output control unit 122e outputs the power supply information generated by the generation unit 122c. With this configuration, the user of the vehicle 100 can know the power supply function provided in the vehicle 100 in the case of disaster or at the time of disaster prevention.

### Second Embodiment

Hereinafter, a second embodiment will be described. In the first embodiment, the vehicle 100 generates and outputs the power supply information. However, in a second embodiment, the communication equipment 200 generates and outputs the power supply information. Specifically, a disaster support system according to the second embodiment includes another communication equipment in place of the communication equipment 200 according to the first embodiment. Hereinafter, the functional configuration of the communication equipment according to the second embodiment will be described. Note that, the same configuration as that of the disaster support system 1 according to the first embodiment is designated by the same reference symbol, and detailed description thereof will be omitted.

### Functional Configuration of Communication Equipment

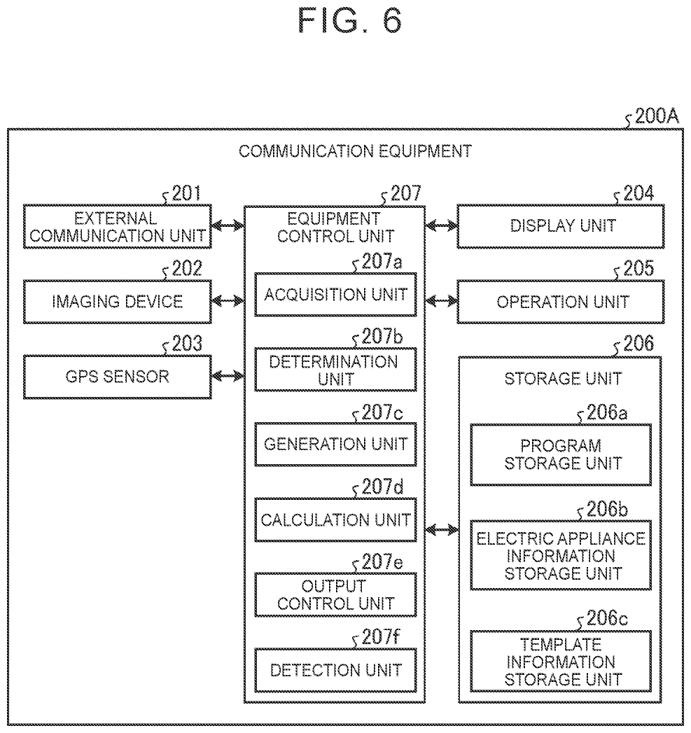

FIG. 6 is a block diagram showing a functional configuration of the communication equipment according to the second embodiment. Communication equipment 200A shown in FIG. 6 includes an external communication unit 201, an imaging device 202, a GPS sensor 203, a display unit 204, an operation unit 205, a storage unit 206, and an equipment control unit 207.

Under the control of the equipment control unit 207, the external communication unit 201 transmits various types of information input from the equipment control unit 207 to the vehicle 100 or to the outside in accordance with a predetermined communication standard. Further, the external communication unit 201 outputs various types of information received from the vehicle 100 or from the outside to the equipment control unit 207. Here, the predetermined communication standard is a standard using a mobile phone line, for example, at least one of the fourth generation mobile communication system (4G), the fifth generation mobile communication system (5G), Wi-Fi, and Bluetooth. The external communication unit 201 is configured using a communication module or the like.

Under the control of the equipment control unit 207, the imaging device 202 generates image data by capturing an image at a predetermined angle of view, and outputs the image data to the equipment control unit 207. The imaging device 202 is configured using one or more lenses, an aperture, and a complementary metal oxide semiconductor (CMOS) image sensor or a charge coupled device (CCD) image sensor, for example.

The GPS sensor 203 receives signals from a plurality of GPS satellites or transmission antennas, calculates position information related to the position (longitude and latitude) of the communication equipment 200A based on the received signals, and outputs the calculation result to the equipment control unit 207. The GPS sensor 203 is configured using a GPS receiving sensor or the like.

The display unit 204 displays information related to the communication equipment 200A and various types of information transmitted from the vehicle 100 under the control of the equipment control unit 207. The display unit 204 is configured using a display such as a liquid crystal display or an organic EL.

The operation unit 205 receives inputs of various operations by the user and outputs operation signals corresponding to the various received operation contents to the equipment control unit 207. The operation unit 205 is configured using a touch panel, buttons, switches, and the like.

The storage unit 206 stores various types of information related to the communication equipment 200A. The storage unit 206 corresponds to a program storage unit 206a that stores various programs executed by the communication equipment 200A, an electric appliance information storage unit 206b that stores the power consumption of the preset electric appliances, and a template information storage unit 206c that stores template information for applying a known template matching or the like to the captured image corresponding to the image data. The storage unit 206 is configured using a read-only memory (ROM), a random access memory (RAM), an SSD, a flash memory, or the like.

The equipment control unit 207 controls each unit constituting the communication equipment 200A. The equipment control unit 207 is configured using a memory and a processor provided with hardware such as a CPU, a field programmable gate array (FPGA) or a digital signal processor (DSP). The equipment control unit 207 includes an acquisition unit 207a, a determination unit 207b, a generation unit 207c, a calculation unit 207d, an output control unit 207e, and a detection unit 207f. Note that, in the second embodiment, the equipment control unit 207 functions as a control device.

The acquisition unit 207a acquires the SOC of the secondary battery 106 from the first detection unit 111 of the vehicle 100 via the external communication unit 201. Further, the acquisition unit 207a acquires the vehicle type information of the vehicle 100 from the vehicle type information storage unit 121a of the storage unit 121 of the vehicle 100 via the external communication unit 201. Further, the acquisition unit 207a acquires the SOC of the secondary battery 106 from the first detection unit 111, acquires the remaining amount of fuel in the fuel tank 114 from the third detection unit 115, and acquires the environmental information detected by the fourth detection unit 116 of the vehicle 100, via the external communication unit 201.

The determination unit 207b determines whether the vehicle 100 is provided with the power generation function capable of supplying power to the secondary battery 106 using the predetermined fuel based on the vehicle type information acquired by the acquisition unit 207a. Further, the determination unit 207b determines whether predetermined information has been input via the external communication unit 201 or the operation unit 120d.

The generation unit 207c generates the power supply information related to power supply from the in-vehicle outlet 112 based on the SOC of the secondary battery 106 of the vehicle 100 acquired by the acquisition unit 207a.

The calculation unit 207d calculates the power supply electric energy that the secondary battery 106 of the vehicle 100 can supply to the outside.

The output control unit 207e outputs the power supply information generated by the generation unit 207c to at least one of the display unit 204 and the display unit 120e of the vehicle 100. Further, the output control unit 207e outputs the usable number of times and the usable time of the electric appliance calculated by the calculation unit 207d to the display unit 204 such that the usable number of times and the usable time are displayed in the vicinity of the electric appliance shown in the captured image.

The detection unit 207f executes a detection process of detecting the electric appliance by applying a known template matching or the like to the captured image corresponding to the image data based on the image data acquired by the acquisition unit 207a and the template information stored in the template information storage unit 206c.

### Process Executed by Communication Equipment

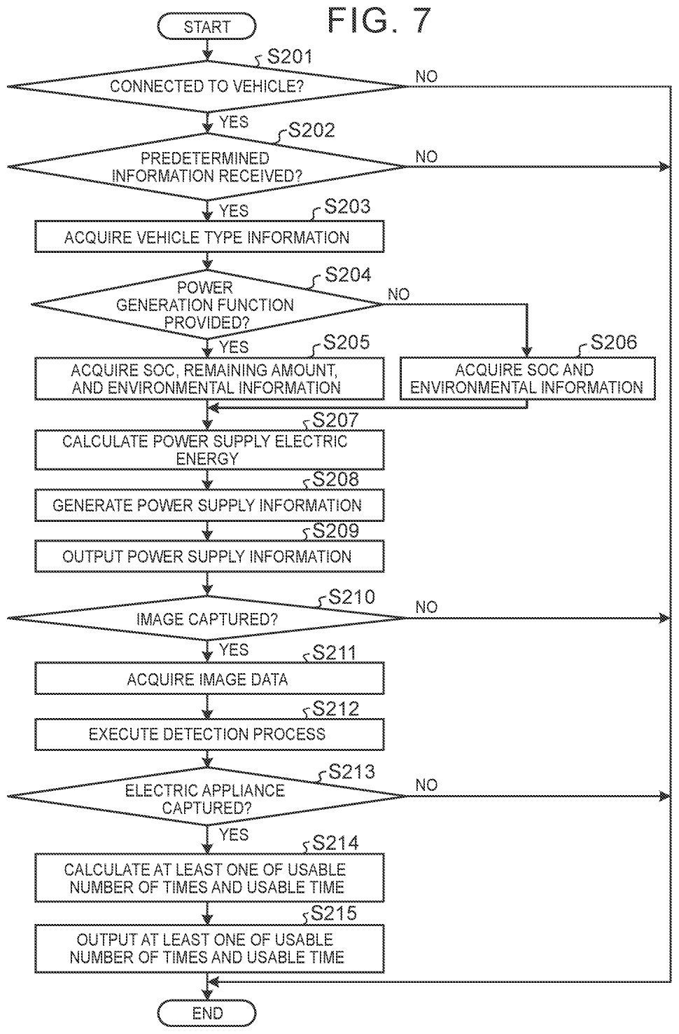

Next, a process executed by the communication equipment 200A will be described. FIG. 7 is a flowchart showing an outline of the process executed by the communication equipment 200A.

As shown in FIG. 7, first, the determination unit 207b determines whether the communication equipment 200A is connected to the vehicle 100 (step S201). When the determination unit 207b determines that the communication equipment 200A is connected to the vehicle 100 (step S201: Yes), the communication equipment 200A proceeds to step S202 that will be described later. On the other hand, when the determination unit 207b determines that the communication equipment 200A is not connected to the vehicle 100 (step S201: No), the communication equipment 200A ends this process.

Steps S202 to S208 respectively correspond to steps S101 to S107 in FIG. 3. Further, step S209 corresponds to step S110 in FIG. 3. After step S209, the communication equipment 200A proceeds to step S210.

In step S210, the determination unit 207b determines whether the imaging device 202 has captured an image. When the determination unit 207b determines that the imaging device 202 captures an image (step S210: Yes), the communication equipment 200A proceeds to step S211 that will be described later. On the other hand, when the determination unit 207b determines that the imaging device 202 does not capture an image (step S210: No), the communication equipment 200A ends this process.

In step S211, the acquisition unit 207a acquires the image data generated by the imaging device 202.

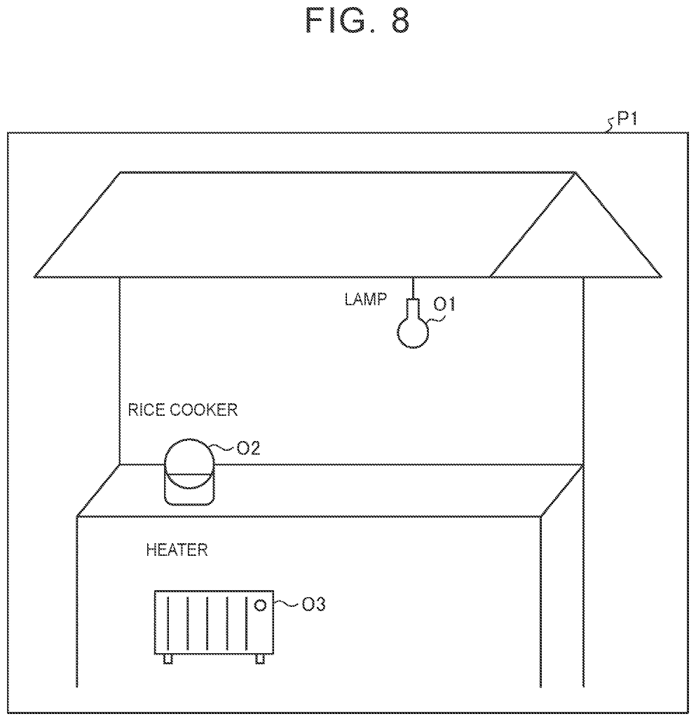

Subsequently, the detection unit 207f executes the detection process of detecting the electric appliance by applying a known template matching or the like to the captured image corresponding to the image data based on the image data acquired by the acquisition unit 207a and the template information stored in the template information storage unit 206c (step S212). FIG. 8 is a diagram schematically illustrating an example of the detection process executed by the detection unit 207f. As shown in FIG. 8, the detection unit 207f detects the electric appliances captured in a captured image P2, names of the electric appliances, and display areas by applying the template matching or the like to a captured image P1 using the template information stored in the template information storage unit 206c. In this case, as shown in FIG. 8, the detection unit 207f detects a lamp O1, a rice cooker O2, and a heater O3 as the electric appliances from the captured image P2. Note that, the detection unit 207f detects the electric appliances from the captured image P1 using a known template matching or the like. However, the detection unit 207f may detect the electric appliances from the captured image P1 by a method using machine learning such as deep neural network (DNN), for example. In this case, the detection unit 207f may detect the electric appliances captured in the captured image P1, the names of the electric appliances, and the display areas by inputting the image data as the input data using a learner learned in advance using a plurality of the image data in which the electric appliances are captured, and outputting the electric appliances, the names of the electric appliances, and the display areas as the output data.

After that, the determination unit 207b determines whether the detection unit 207f can detect the electric appliances from the captured image P1 (step S213). When the determination unit 207b determines that the detection unit 207f can detect the electric appliances from the captured image P1 (step S213: Yes), the communication equipment 200A proceeds to step S214 that will be described later. On the other hand, when the determination unit 207b determines that the detection unit 207f cannot detect the electric appliances from the captured image P1 (step S213: No), the communication equipment 200A ends this process.

Subsequently, in step S214, the calculation unit 207d calculates at least one of the usable number of times and the usable time of each electric appliance detected by the detection unit 207f based on the electric appliances detected by the detection unit 207f and the electric appliance information stored in the electric appliance information storage unit 206b.

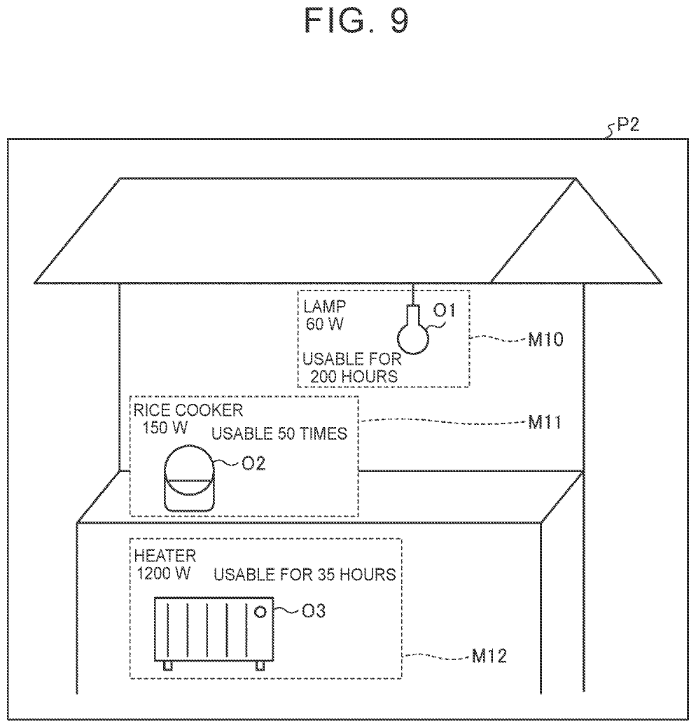

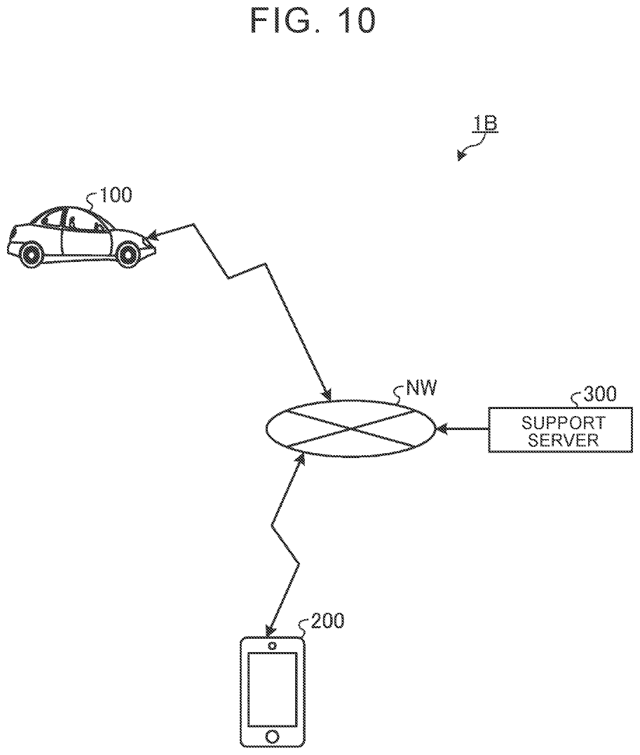

Subsequently, the output control unit 207e outputs the usable number of times and the usable time of each electric appliance calculated by the calculation unit 207d to the display unit 204 such that the usable number of times and the usable time are displayed in the vicinity of the corresponding electric appliance shown in the captured image (step S215). FIG. 9 is a diagram showing an example of at least one of the usable number of times and the usable time output by the output control unit 207e. As shown in FIG. 9, the output control unit 207e outputs the data such that at least one of the usable number of times and the usable time is superimposed in the vicinity of each of the electric appliances shown in the captured image P2 displayed by the display unit 204. For example, as shown in FIG. 9, in the case of the lamp O1 (of which power consumption is 60 W), the output control unit 207e outputs a message M10 indicating that the lamp O1 can be used for 200 hours as the usable time. Further, in the case of the rice cooker O2 (of which power consumption is 150 W), the output control unit 207e outputs a message M12 indicating that the rice cooker O2 can be used 50 times as the usable number of times. Still further, in the case of the heater O3 (of which power consumption is 1200 W), the output control unit 207e outputs a message M13 indicating that the heater O3 can be used for 35 hours as the usable time. With this configuration, the user can intuitively understand the usable number of times or the usable time of the electric appliance when the user uses the electric appliance via the in-vehicle outlet 112 of the vehicle 100. Note that, although the output when each electric appliance is used independently is described in FIG. 9, the output is not limited to this. For example, when the user selects two or more electric appliances from the electric appliances via the operation unit 205, the calculation unit 207d may calculate at least one of the usable number of times and the usable time based on the total power consumption of the selected electric appliances, and the output control unit 207e may output at least one of the usable number of times and the usable time of the electric appliances selected by the user to the display unit 204. After step S215, the communication equipment 200A ends this process.

According to the second embodiment described above, the same effect as that of the first embodiment can be achieved, that is, the user can understand the power supply information related to the power supply by the secondary battery 106 mounted on the vehicle 100.

Further, according to the second embodiment, the calculation unit 207d calculates at least one of the usable number of times and the usable time of each electric appliance detected by the detection unit 207f based on the electric appliance detected by the detection unit 207f and the electric appliance information stored in the electric appliance information storage unit 206b. After that, the output control unit 207e outputs the usable number of times and the usable time of each electric appliance calculated by the calculation unit 207d to the display unit 204 such that the usable number of times and the usable time are displayed in the vicinity of the corresponding electric appliance shown in the captured image. With this configuration, the user can intuitively understand the usable number of times or the usable time of the electric appliance in real time when the user uses the electric appliance via the in-vehicle outlet 112 of the vehicle 100.

In the second embodiment, the output control unit 207e outputs the data to the display unit 204 by superimposing the usable number of times and the usable time of the electric appliance calculated by the calculation unit 207d on one captured image such that the usable number of times and the usable time are displayed in the vicinity of the electric appliance captured in the captured image. However, for example, the output control unit 207e may output data to the display unit 204 by superimposing the usable number of time and the usable time of the electric appliance calculated by the calculation unit 207d on a video such that the usable number of times and the usable time are displayed in the vicinity of the electric appliance captured in the captured image.

### Third Embodiment

Hereinafter, a third embodiment will be described. In the first and second embodiments, the vehicle 100 or the communication equipment 200A generates and outputs the power supply information. However, in the third embodiment, a server generates and outputs the power supply information. Hereinafter, the disaster support system according to the third embodiment will be described. Note that, the same configuration as that of the disaster support system 1 according to the first embodiment is designated by the same reference symbol, and detailed description thereof will be omitted.

### Disaster Support System

FIG. 10 is a diagram showing a schematic configuration of a disaster support system according to the third embodiment. A disaster support system 1B shown in FIG. 10 can communicate with the vehicle 100 and the communication equipment 200 via a network NW in addition to the configuration of the disaster support system 1 according to the first embodiment, and further includes a support server 300 that outputs various types of information. The network NW is composed of, for example, the Internet network and a mobile phone network.

### Functional Configuration of Support Server

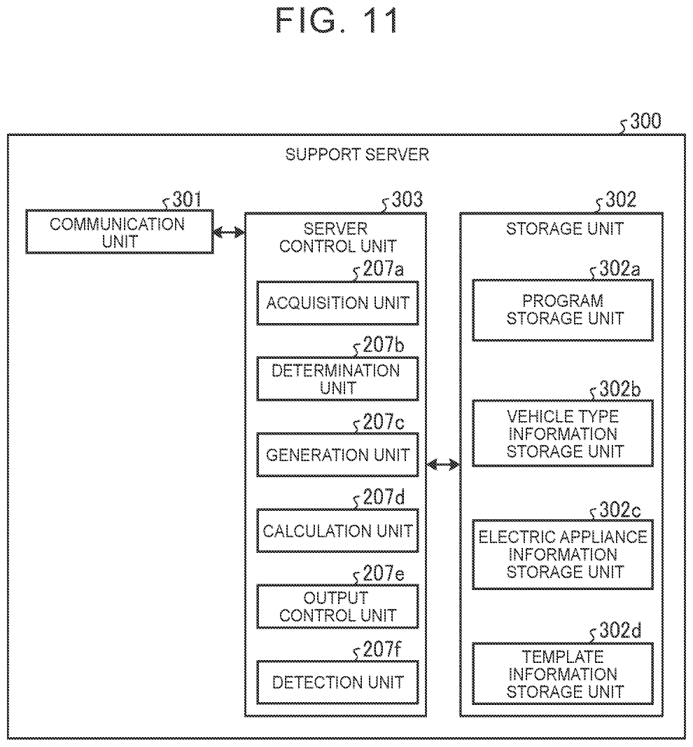

Next, the support server 300 will be described. FIG. 11 is a block diagram showing the functional configuration of the support server 300. The support server 300 shown in FIG. 11 includes a communication unit 301, a storage unit 302, and a server control unit 303.

Under the control of the server control unit 303, the communication unit 301 receives various types of information from the vehicle 100 or the communication equipment 200 via the network NW, and transmits various types of information to the vehicle 100 or the communication equipment 200. The communication unit 301 is configured using a communication module or the like capable of transmitting and receiving various types of information.

The storage unit 302 records various types of information related to the support server 300. The storage unit 302 includes a program storage unit 302a that stores various programs executed by the support server 300, a vehicle type information storage unit 302b that stores vehicle type information, an electric appliance information storage unit 302c that stores electric appliance information, and a template information storage unit 302d that stores a template. The storage unit 302 is configured using a DRAM, a ROM, a flash memory, an HDD, an SSD, or the like.

The server control unit 303 controls each unit constituting the support server 300. The server control unit 303 is configured using a memory and a processor provided with hardware such as a CPU. The server control unit 303 is provided with the same function as the equipment control unit 207 of the communication equipment 200, and includes the acquisition unit 207a, the determination unit 207b, the generation unit 207c, the calculation unit 207d, the output control unit 207e, and the detection unit 207f. Note that, in the third embodiment, the server control unit 303 functions as a control device.

### Process Executed by Support Server

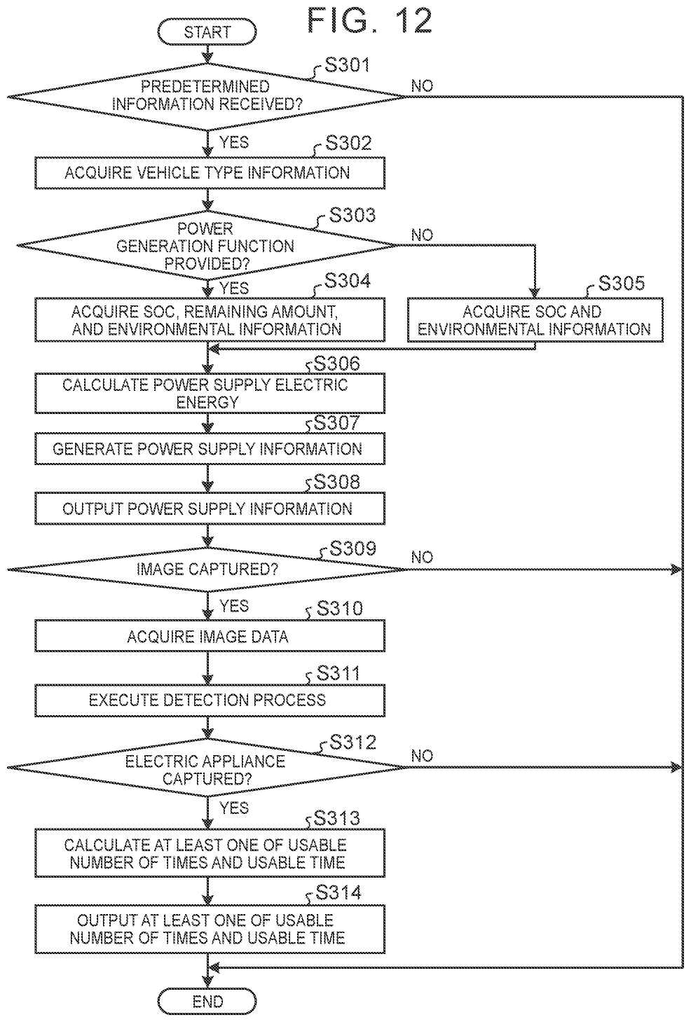

Next, a process executed by the support server 300 will be described. FIG. 12 is a flowchart showing an outline of the process executed by the support server 300. In FIG. 12, steps S301 to S314 respectively correspond to steps S202 to S215 in FIG. 7.

According to the third embodiment described above, similar to the first and second embodiments, the user can understand the power supply information related to the power supply by the secondary battery 106 mounted on the vehicle 100.

### Other Embodiments

Further, in the first to third embodiments, the above-mentioned “unit” can be read as “circuit” or the like. For example, the control unit can be read as a control circuit.

Further, the program to be executed by the disaster support system according to the first to third embodiments is stored and provided as file data in an installable format or an executable format in a computer-readable storage medium such as a compact disc (CD)-ROM, a flexible disk (FD), a compact disc-recordable (CD-R), or a digital versatile disk (DVD), universal serial bus (USB) media, or flash memory.

The program to be executed by the disaster support system according to the first and third embodiments may be configured to be stored in a computer connected to a network such as the Internet and provided through downloading via the network.

Note that, in the description of the flowchart in the present specification, the order of the processing between steps is clarified using expressions such as “first”, “after that”, and “subsequently”. However, the order of processing required for realizing the embodiment is not always uniquely defined by those representations. That is, the order of processing in the flowchart described in the present specification can be changed within a consistent range.

Further effects and modifications can be easily derived by those skilled in the art. The broader aspects of the disclosure are not limited to the particular details and representative embodiments shown and described above. Accordingly, various modifications can be made without departing from the spirit or scope of the general inventive concept as defined by the appended claims and their equivalents.

What is claimed is:

1. A control device comprising a processor configured to:
acquire a charging rate of a secondary battery from a vehicle provided with the secondary battery that is able to supply power to an outside and an outlet that is electrically connected to the secondary battery and with which the power is able to be supplied to an electric appliance;
generate power supply information related to the power supply using the outlet based on the charging rate; and
output the power supply information.

2. The control device according to claim 1, wherein the power supply information includes at least a rated output power, the charging rate, and a power supply available time.

3. The control device according to claim 1, wherein the processor:
acquires vehicle type information related to a type of the vehicle;
determines whether the vehicle is provided with a power generation function that is able to supply power to the secondary battery using a predetermined fuel based on the vehicle type information;
acquires a remaining amount of the predetermined fuel when the vehicle is provided with the power generation function; and
generates the power supply information based on the remaining amount and the charging rate.

4. The control device according to claim 3, wherein the processor:
acquires environmental information related to an environment around the vehicle;
calculates a power supply electric energy with which the secondary battery is able to supply power based on the environmental information, the remaining amount, and the charging rate; and
generates the power supply information based on the power supply electric energy.

5. The control device according to claim 4, wherein the processor:
calculates at least one of a usable number of times and usable time of each of a plurality of the electric appliances set in advance based on the power supply electric energy; and
outputs at least one of the usable number of times and the usable time of the each of the electric appliances.

6. The control device according to claim 1, wherein:
power consumption of the electric appliance connected to the outlet is acquired;
at least one of a usable number of times and usable time of the electric appliance is calculated based on the power consumption and the power supply information; and
at least one of the usable number of times and the usable time is output.

7. The control device according to claim 1, wherein the processor outputs the power supply information to communication equipment associated with the vehicle.

8. The control device according to claim 1, wherein the control device is implemented in the vehicle.

9. The control device according to claim 1, wherein
the control device is implemented in a server that is communicable with the vehicle via a network.

10. The control device according to claim 1, wherein the control device is implemented in communication equipment that is communicable with the vehicle.

11. The control device according to claim 10, wherein the processor:
acquires image data captured by an imaging device;
detects the electric appliance captured in a captured image corresponding to the image data;
calculates at least one of a usable number of times and usable time of the electric appliance based on the power supply information; and
superimposes at least one of the usable number of times and the usable time on the captured image and outputs the captured image.

12. The control device according to claim 1, wherein when the processor receives at least one of disaster information and disaster prevention information from the outside, the processor outputs the power supply information.

13. A disaster support system, comprising:
a vehicle provided with a secondary battery that is able to supply power to an outside and an outlet that is electrically connected to the secondary battery and with which the power is able to be supplied to an electric appliance; and
a control device provided with a processor configured to acquire a charging rate of the secondary battery, generate power supply information related to the power supply using the outlet based on the charging rate, and output the power supply information.

14. A non-transitory storage medium storing a program that causes to execute operations comprising:
acquiring a charging rate of a secondary battery from a vehicle provided with the secondary battery that is able to supply power to an outside and an outlet that is electrically connected to the secondary battery and with which the power is able to be supplied to an electric appliance;
generating power supply information related to the power supply using the outlet based on the charging rate; and
outputting the power supply information.
